(19) United States
(12) Patent Application Publication
(10) Pub. No.: US 2014/0024130 A1
(43) Pub. Date: Jan. 23, 2014

(54) CHEMICAL BREATH TESTING DEVICE FOR DETECTING ALCOHOL INCLUDING A TESTING TUBE AND AN INFLATABLE BAG

(71) Applicant: CONTRALCO, Gignac (FR)

(72) Inventors: Antoine MARIN, Montpellier (FR); Eric CONDESSE, Montpellier (FR)

(73) Assignee: CONTRALCO, Gignac (FR)

(21) Appl. No.: 14/025,214

(22) Filed: Sep. 12, 2013

Related U.S. Application Data
(63) Continuation-in-part of application No. PCT/FR2012/000092, filed on Mar. 15, 2012.

(30) Foreign Application Priority Data
Mar. 16, 2011 (FR) 11/00798
Mar. 25, 2011 (MC) 2577

(51) Int. Cl. G01N 21/78

(52) U.S. Cl. CPC G01N 21/783
USPC 436/131; 422/405

(57) ABSTRACT

The invention relates to a chemical breath testing device including a transparent testing tube which cooperates with an outlet piece incorporating a valve and fitted to an inflatable bag. The testing tube is provided with a member for pushing the valve which is formed by the bottom of a cap. The outer sidewall of the cap is resiliently deformable and serves to form an interlocking connection between the testing tube and the outlet piece. The cap is mounted in a mobile manner at the end of the testing tube and carries a cutting blade for cutting a seal closing off the outlet of the testing tube, of which the rim forms a counter-blade.

### CROSS-REFERENCE TO RELATED APPLICATIONS

This application is a continuation-in-part of application no. PCT/FR2012/000092 filed Mar. 15, 2012, which claims the benefit of French application 11/00798 filed Mar. 16, 2011 and Monaco application no. 2577 filed Mar. 25, 2011.

### FIELD OF THE INVENTION

The invention relates to the field of research into the properties of biological materials and is more particularly relevant to research into the characteristics of the breath using a chemical device putting into effect a testing tube housing a substrate impregnated with a reagent. It concerns a device commonly referred to as a breathalyzer, which comprises a testing tube and an inflatable bag.

### BACKGROUND OF THE INVENTION

In the field of research into the properties of biological materials, there are known devices commonly, referred to as breathalyzers which are designed to detect the presence of alcohol in the breath. Such devices make it possible, by analyzing the breath blown into the device by a user, to determine a significant threshold of alcohol present in the breath in order to determine the user's blood alcohol content. Among these devices a distinction is made between those operating on the electronic principle and those operating on the chemical principle using a testing tube and an inflatable bag.

Chemical devices for analyzing the breath include a transparent testing tube, in particular made of glass, wherein an air-permeable substrate is contained in a leak-tight manner. Such a substrate is in particular in the finely-divided state, such as a silica-based material or the like, or may take the form of a textile type substrate. The substrate is impregnated with a reactive agent, which is for example potassium dichromate in the specific case of a breathalyzer. The test is performed by passing the breath of the user through the testing tube in a defined amount, then observing the behavior of the substrate: a progressive change in the color of the substrate in the direction of the air flow through the testing tube indicates a corresponding level of alcohol contained in the users' breath. The transparent nature of the testing tube makes it possible to observe a possible change of state of the substrate, at least one mark on the testing tube being commonly used to indicate a threshold of the user's blood alcohol content which must not be exceeded.

The substrate is confined inside the testing tube so as to protect it from the external environment before a test is performed. According to a common solution, the outlets of the testing tube are closed off by respective seals which are designed to be pierced extemporaneously as the test is being performed, in order to allow air to circulate through the testing tube. To contain the substrate in a specific part of the testing tube, in particular the median part, screens or similar perforated members are respectively placed on both sides of that part of the testing tube wherein the substrate is confined. These arrangements are designed in particular to hold the substrate mass in a specific area of the testing tube, and more particularly to avoid dispersion of the granular material forming the substrate inside the testing tube. Calibration of the test takes into account a defined volume of air passing through the substrate at a substantially constant rate. To calibrate the volume of air flowing through the testing tube for a given test, an inflatable bag of a corresponding volume is commonly used. The inflatable bag is filled by the user by blowing in air, to calibrate the quantity of air blown in which passes through the reagent in the testing tube during the test. The inflatable bag is fitted with an outlet piece for receiving the testing tube to facilitate the placement thereof in mutual cooperation. According to various alternative embodiments, either the testing tube is used to fill the inflatable bag by means of air blown in by the user through the testing tube, or the inflatable bag is first filled directly by the user by blowing air through the outlet piece, then the testing tube is mounted on the inflatable bag and an operator empties the volume of air contained therein through the testing tube. Prior to using the testing tube, it is necessary to retract the barriers formed by the seals, in particular by perforating the seals, to allow the passage of air through the testing tube.

For example, according to FR 2746186 (SAINT GAL DE PONS RENAUD), caps cover the ends of the testing tube, each having a boss provided with an axial opening for the passage of air. The caps are slidably mounted on the testing tube to allow the seals to be ruptured by the bosses when the caps are pressed into the ends of the testing tube. The axial apertures in the bosses are each extended outwardly from the testing tube by respective conduits. One of the conduits serves to enable the user to blow air into the testing tube; the other conduit is used for mounting the testing tube on the inflatable bag by fitting inside the outlet piece included thereon. The conduits can be incorporated into the corresponding cap, and/or fitted by insertion into the axial aperture extemporaneously when assembling the testing tube with the inflatable bag. This solution is applied particularly in cases where the testing tube is used as a means for filling the inflatable bag by the user.

For example, according to FR 2738341 (CONTRALCO), the inflatable bag is provided with a valved outlet piece, the valve being mounted within the outlet piece between an open position allowing the passage of air and a closed position preventing the passage of air through the outlet piece. This solution is applied in particular where filling of the inflatable bag is accomplished by the user via the outlet piece. The mobility of the valve is caused by air under pressure which is applied against the valve, either for opening when the user fills the inflatable bag by blowing, or for closing under the effect of the air pressure inside the filled inflatable bag. When performing the test, the inflatable bag is first filled with air by the user and is kept inflated by spontaneous closure of the valve. Cooperation between the testing tube and the outlet piece causes the valve to move to the open position, the testing tube being fitted with a pushing finger which urges the valve to the bottom of the outlet piece. The free end of the outlet piece opposite the end attaching it to the inflatable bag is configured as a perforator to break the seal when the testing tube is mounted on the inflatable bag.

It has become apparent in practice that there is a need to improve upon devices for chemical analysis of the breath, taking into consideration various constraints and difficulties that need to be overcome. The assembly of the structural elements comprising the device and the operations required to perform the test should be capable of being accomplished easily and quickly. The connection between the testing tube and the outlet piece should be made as airtight as possible, and it is desirable that the means employed to make this connection be structurally simple by limiting the number of elements to be manipulated and by facilitating the mutual cooperation thereof. The passage of air through the testing tube should be smooth and at a constant rate. Given that devices for chemical analysis of the breath are single-use disposable products, the construction of such devices should be as simple as possible without affecting the effectiveness and reliability of the analysis performed, and the said construction should be achievable at reduced cost so as not to render the use of the devices economically prohibitive.

### SUMMARY OF THE INVENTION

The present invention provides a device for chemical analysis of the breath of which the operating principle and construction are improved compared with existing devices, in particular by offering a satisfactory compromise with respect to the combination of the difficulties to be overcome and the constraints to which these devices are subject.

The device of the present invention is a chemical breath testing device. The device comprises a transparent testing tube with an inlet and outlet end, wherein at least one end of the testing tube is closed off by at least one seal. An air permeable substrate of granular material or a membrane is disposed within the testing tube and is impregnated with a reagent that is reactive to an analyte in human exhale. The substrate is retained by a set of screens disposed at each end of the substrate. At least one end cap is disposed on the sealed end of the testing tube and in sliding engagement with the testing tube from a first position to a second position. The cap contains a rupturing member for rupturing the seal, and the cap is further provided with an axial conduit for the passage of air therethrough. An inflatable bag, which cooperates with the end of the testing tube that has the cap, contains a tubular outlet piece that is fluidly connected with the inflatable bag. The outlet piece incorporates a valve that is moveable from an open to closed position to allow air blown into the bag to remain inside the bag. The cap also has a junction member that is formed by the outside surfaces of the cap, and which is configured to sealingly engage the tubular outlet piece to create an air-tight seal between the cap and outlet piece. The cap is also further equipped with a pushing member formed by a shoulder on the cap that provides axial support for urging the valve towards the open position and towards the inside of the inflatable bag when the junction member receives the outlet piece.

The invention itself can be used by first preparing the testing tube by moving the cap from the first position to the second position. This movement causes the seal to rupture, thus allowing the testing tube to receive air. The testing tube is then used by sealingly engaging the filled inflatable bag with the junction member, so that the testing tube is operatively associated with the outlet piece and inflatable bag. This engagement causes the pushing member to open the valve and thus allowing the passage of air through the axial conduit and into the internal volume of the testing tube. Thus as the air passes through the substrate, it reacts with the reagent on said substrate.

In an alternative embodiment, both the inlet and outlet ends are closed off by seals on each end, and caps are provided on both ends. The inflatable bag can also either be received by the junction member on the inlet end of the testing tube or the outlet end of the testing tube. If the inlet is receiving the inflatable bag, the inflatable bag is filled prior to placing it on the inlet end. If the outlet is receiving the inflatable bag, the inflatable bag is placed on the outlet end in a deflated state and is filled as the testing tube is used with air entering through the inlet end.

In another preferred embodiment, the seals, caps, and air permeable substrate are arrange symmetrically with the testing tube, so that the testing tube is symmetrical and there is no distinction between an inlet or outlet end, and either end of the testing tube can be operatively associated with the outlet piece and inflatable bag.

Another embodiment of the invention has a shoulder formed on an inner surface of the outlet piece, along with a valve guide, a stop, and air channel. The valve is formed as a circular block with tapered sides and lugs on the bottom, wherein the block may be hollow. Thus when the valve is in the closed position, the thicker end of the valve is in contact with the shoulder. When the pushing member pushes the valve towards the inside of the bag, the valve is moved to the open position while being guided by the valve guide, where the tapered shape of the valve allows a gap to form between the valve and shoulder, thereby allowing the passage of air from the air channel and through the valve. The axial shoulder can also be used to limit the travel of the outlet piece on the junction member while the stop limits the travel of the valve.

A further embodiment also includes markings on the testing tube. These markings include a first marking that is used to indicate the second position of the cap and a second marking that is used to indicate an amount of analyte contained in the air and which has been reacted with the reagent on the substrate. The amount of analyte can be indicated by the reagent on the substrate changing to a new color, such that when a portion of the substrate changes to the new color that surpasses the second marking, the portion of the substrate surpassing the second marking indicates that a measure level has been surpassed. This measure level can be the maximum allowable blood alcohol level when the analyte is ethanol in human exhale. The second marking may be positioned half way along the length of the testing tube, also referred to as the middle of the testing tube, so that the tube is symmetrical.

The screens of one embodiment are sized to be slightly larger than the inner diameter of the testing tube. As such, when the substrate and screens are placed inside the testing tube, the interference created between the testing tube and screen creates an interference fit which allows the screens to securely hold the substrate inside the testing tube. In a preferred embodiment, the substrate is positioned symmetrically in the middle of the testing tube so that the same amount of substrate and analyte is on either side of the middle of the tube.

The cap of an alternative embodiment takes the form of a blind sleeve having a flexible and deformable outer wall which resiliently caps the outer wall of the testing tube with tolerances sufficient enough to allow slideable engagement therewith. The outer sidewall of the cap can also include on its inner face a stop for axial positioning of the cap on the testing tube in the initial position. Centering ribs may also be provided on the inner face of the outer sidewall of the cap to provide resilient bearing contact against the wall of the testing tube. An annular sealing member between the cap and the tubular space of the outlet piece may also be provided on the outer face of the outer sidewall of the cap.

The axial conduit of the invention in one embodiment is formed in the bottom of the cap for the passage of air through the cap.

An embodiment of the rupturing member is provided in the form of a cutting blade of radial geometry. The blade is sized to be about the size of the inner diameter of the testing tube to allow the testing tube to form a counter-blade. The edge of the blade can also include teeth and ribs for providing axial reinforcement. The ribs themselves extend as far as the tips of the teeth.

A further embodiment of the invention has the device of the invention used by preparing the testing tube for use by moving the at least one end cap from the first to second position. The inflatable bag in inflated either prior to, after, or while the testing tube is prepared by having a user blow into the outlet piece and filling to bag to a desired level. After the testing tube is prepared and the inflatable bag filled, the outlet piece is operatively engaged with the junction member. After engagement, the collected exhale is forced from the bag and through the testing tube by compressing the inflatable bag.

Another embodiment of the invention has a transparent testing tube with two ends, wherein both ends of the testing tube are closed off by at least one seal; an air permeable substrate fixedly disposed within the testing tube and impregnated with a reagent reactive to an analyte in human exhale, wherein the substrate is positioned symmetrically within the middle of the tube; the same end cap is disposed on each sealed end of the testing tube and in sliding engagement with the testing tube so that each cap is movable from a first position to a second position, with both caps having an axial conduit for the passage of air therethrough and containing a rupturing member for rupturing the seal; an inflatable bag which cooperates with either end of the symmetric testing tube that has the cap, the inflatable bag containing a tubular outlet piece fluidly connected with the inflatable bag, wherein the outlet piece incorporates a valve moveable from an open to closed position to allow air blown into the bag to remain inside the bag; and such that the inflatable bag; a junction member that is formed by the outside surfaces of the cap, and which is configured to sealingly engage the tubular outlet piece of the inflatable bag to create an air-tight seal between the cap and outlet piece, the cap being further equipped with a pushing member formed by a shoulder on the cap that provides axial support for urging the valve in the outlet piece towards the open position and towards the inside of the inflatable bag when the junction member receives the outlet piece, wherein the testing tube is prepared for usage by moving both caps from the first position to the second position to rupture each of the seals, and wherein the testing tube is used to analyze the person's breath for presence of the analyte.

The embodiment of the invention may also have one or more markings on the testing tube for indicating the second position(s) of the cap(s), and/or to indicate the amount of analyte contained in human exhale; wherein the analyte markings are arranged symmetrically with respect to the testing tube and substrate such that either end of the testing tube can be inserted into the outlet piece and still provide an indication of the quantity of analyte in human exhale.

### BRIEF DESCRIPTION OF THE DRAWINGS

An exemplary embodiment of the present invention will be described with reference to the figures in the attached drawings in which:

FIGS. 1A and 1B are an illustration in axial cross-section of a device of the present invention, including a testing tube 1 with an outlet piece 3 fitted to an inflatable bag 2;

FIGS. 2A, 2B and 2C are transverse cross-sectional views of the testing tube and outlet piece taken along lines A-A and B-B of testing tube 1 and C-C of outlet piece 3;

FIG. 3 is an illustration in axial cross-section of the outlet piece 3 of FIG. 1B in the situation where the inflatable bag is being filled, in which a valve included therein is in the retracted position to allow a passage of air through the outlet piece;

FIGS. 4A and 4B are illustrations in axial cross-section of the device of the present invention, in which, in FIG. 4A, the inflated bag having the valve included in the outlet piece is in the closed position preventing a passage of air through the outlet piece, and is ready for connection to the testing tube shown in FIG. 4B in which the testing tube is in a position of use, the seal closing off the inlet end being broken; and

FIG. 5 is an illustration in axial cross-section of the device shown of the present invention, wherein the testing tube and outlet piece are assembled together.

### DETAILED DESCRIPTION OF THE PREFERRED EMBODIMENTS

The device of the present invention is a chemical breath testing device, which includes a transparent testing tube cooperating with an inflatable bag. The testing tube contains an air-permeable substrate that is impregnated with a reagent reactive to an analyte in human exhale, such a substrate being in particular a granular material. At least one end of the testing tube is closed off by at least one seal. The seal or seals are preferably provided particularly in sheet form, such as an aluminum sheet, which is heat-sealed to the corresponding end of the testing tube. The aluminum sheet may be bonded with a polymer layer, such as a low density poly ethylene or ethylene-acrylic acid copolymer, or coated with a heat-activated adhesive that forms the heat seal with the glass surface, as is known to those of ordinary skill in the packaging arts. The seal may also be a clear flexible film incorporating for example an SiO₂, PVDC, or EVOH layer to provide an oxygen/moisture barrier layer, also as known in the art. In a preferred embodiment, both ends of the testing tube are closed by seals in their corresponding locations.

The inflatable bag is provided with a tubular outlet piece for receiving a junction member, formed by an outer surface of the cap, with which the testing tube is fitted at one of its ends. The junction member serves to form the assembly between the testing tube and the inflatable bag, providing an air passage between the outlet piece and the internal volume of the testing tube. The junction member formed by the outside surfaces of the cap is configured to sealingly engage the tubular outlet piece of the inflatable bag to create an air-tight seal between the cap and the inner surface of the outlet piece, wherein the outside diameter of the outer sidewall and/or the annular sealing member of the cap and the inner surface of outlet piece are suitably dimensioned to form the seal between the cap and the outlet piece.

The device of the present invention also includes an outlet piece incorporating a valve that is operable by a pushing member included in the testing tube fitted with a cap. The pushing member itself can simply be a shoulder in the top of the cap. Also included is a rupturing member for rupturing the seals to allow the passage of air through the testing tube. The rupturing member can be provided by the cap, being slidably mounted on the testing tube, and a junction member for fitting the testing tube to the outlet piece which forms an air passage therebetween.

More particularly, the outlet piece is an outlet piece incorporating a valve, the valve being operable between an open position and a closed position. The open position allows air to pass through the outlet piece by pushing the valve towards the inside, with the thinner part of the valve leaving a gap between the valve and shoulder. The closed position is a position preventing air from passing through the outlet piece by pushing the valve against the shoulder, closing any gap. A hollow valve may be held in the closed position by the air pressure within the bag pushing against the inside walls of the hollow valve. The testing tube is fitted with a pushing member to urge the valve toward the inside of the inflatable bag to cause the valve to move to the open position as a consequence of the testing tube being received by the outlet piece.

The rupturing member is advantageously formed by a blind cap that covers the corresponding end of the testing tube. This corresponding end is understood to be the end of the testing tube sealed by the at least one of the seals. It will be understood that the at least one of the seals is in particular the seal provided at the proximal end of the testing tube which is received by the outlet piece in the situation where the testing tube and the inflatable bag are assembled. To simplify the construction, implementation and production of the device of the invention at reduced cost, the arrangements provided for the cap fitted to the proximal end of the testing tube are transposed to a cap fitted at the other distal end opposite the testing tube.

The specific features of the arrangement of the rupturing member employed can also be used advantageously for both of the seals. The rupturing member is devoid of weighting and can be advantageously configured as a cutting blade, in particular of circular shape designed to conform to the geometry of the outlet of the testing tube. The blade can have a sharp or beveled edge such that the use of a blade enables the seal to be ruptured by cutting rather than tearing, along a perimeter corresponding to the internal geometry of the testing tube. The rim of the testing tube is preferably even and capable of cooperating with the blade by advantageously forming a counter-blade. The said cutting action causes the seal to retract in the testing position, preventing the formation of an obstruction to the passage of the laminar airflow through the testing tube. The arrangement of the blade-like rupturing member can include a toothed edge thereby improving the even quality with which the seal is cut.

The cap is mounted axially mobile on the testing tube, between an initial first position in which the rupturing member is placed at a distance from the corresponding seal and a second position in which the seal is broken.

The cap, at least the one fitted at the proximal end of the testing tube, is provided with a sidewall for fitting axially on the outlet piece, the sidewall also forming the junction member, and a shoulder for axial support against the valve which forms the pushing member. The shoulder is formed in particular by the blind end face of the cap.

The junction member, the pushing member and the corresponding rupturing member are grouped on the cap provided at the end of the corresponding testing tube. The grouping can be readily accomplished by integrally molding the junction member, the pushing member and the rupturing member with the cap. The construction of the device and the procedures for carrying out the test are simple. The construction of the cap is potentially reduced to a blind sleeve including a preferably thin, flexible and/or deformable sidewall capable of forming resilient bearing surfaces interposed between the testing tube and the outlet piece. The resilience of the sidewall of the cap helps to form an airtight connection between the testing tube and the outlet piece, by the interposition of the said sidewall therebetween. The bottom of the cap is capable of forming the said shoulder, which provides an optimized bearing surface against the valve for its movement to the retracted position, and which serves to limit the extent of the axial conduit in correspondence with the thickness of the bottom of the cap, to reduce pressure losses and to avoid the formation of turbulence in the airflow circulating between the inflatable bag and the internal volume of the testing tube. Preferably, the shoulder is a flat surface around the periphery of the bottom of the cap that can push against the bottom face of the valve to move it from a closed position to an open position. The air flows in laminar fashion over a short path, which is conducive to the effectiveness, accuracy and reliability of the test carried out.

The device can be produced at reduced cost and its packaging requirements are strictly confined to the packaging of a testing tube of small dimensions, in particular axially, and to the inflatable bag from which the outlet piece may project with a limited axial extension, just sufficient to be held in the user's mouth. Sealing of the junction between the testing tube and the inflatable bag is facilitated by minimizing the number of elements that are interposed between the interior volume of the testing tube and that of the outlet piece, and by minimizing their axial dimensions both with respect to each other and in the situation where the testing tube and outlet piece are assembled.

The axial bearing surface of the cap against the valve is optimized and the axial extent of the conduit limited to the thickness of the bottom of the cap, whereas the side wall may be structurally thin and deformable to reduce its cost of manufacture and to improve the air tightness of the connections respectively between the testing tube and the cap and between the cap and the outlet piece. Preferably, the testing tube includes markings, showing the correct testing position and confirming that the seal has been effectively broken.

The thickness of the bottom of the cap can easily be made thicker than the side wall of the cap, so as to strengthen the rupturing member which in one embodiment, is molded integrally with the bottom of the cap. The axial extent of the conduit is reduced to the thickness of the bottom of the cap.

According to a preferred embodiment, the cap is molded integrally with the junction member, the pushing member and the rupturing member. The cap is easy to make at reduced cost, and the arrangements for putting the device into effect are made simple by limiting the number of elements to be manipulated.

The junction member is formed in particular by the outer sidewall of the cap, which envelops the outer wall of the testing tube at its corresponding end and which is capable of being seated, inside a an inner surface of the outlet piece. An axial shoulder limiting the travel of the testing tube is provided inside the outlet piece at the bottom of the inner surface. The cap is structurally reduced to a flexible enclosure which forms the outer wall thereof and which is closed at one of its ends by the bottom of the cap into the thickness of which the axial air passage conduit extends and is delimited. The flexibility of the enclosure formed by the cap is imparted thereto by the thinness of its wall and/or by the material of which it is constituted.

More particularly, the outer sidewall of the cap preferably includes on its inner face a stop for axial positioning of the cap on the testing tube in the initial position. The stop is preferably disposed substantially in an axially median zone of the cap. According to one embodiment, the outer sidewall of the cap includes on its inner face centering ribs providing resilient bearing contact against the wall of the testing tube.

The centering ribs are preferably divided into sets, including a first set of ribs to facilitate mounting and centering of the caps on the testing tube and a set of additional ribs to firmly guide the movement of the cap on the testing tube between the initial position and the testing position. More particularly, a second set of ribs combines the ribs of the first set and the said additional ribs which provide firm relative mobility between the testing tube and the cap, so as to prevent possible inadvertent movement of the cap after it has been moved to the test position. The centering ribs providing resilient bearing contact advantageously include the first set of ribs which extend along the whole of the axial extent of the inside face of the outer sidewall of the cap, and the additional ribs providing firm relative mobility between the cap and the testing tube, which extend axially from the bottom of the cap as far as the stop. These firming ribs participate in forming the stop, in that they create a firm holding point for the cap as it slides along the testing tube. In an accessory manner, the formation of the stop by the firming ribs is supplemented by a localized thickening of the inner face of the outer wall of the cap, forming an annular peripheral bead extending either continuously or discontinuously.

According to one embodiment, the outer sidewall of the cap includes on its outer surface an annular sealing member between the cap and the tubular space of the outlet piece. This annular sealing member can be configured as a lip or the like and is formed in one embodiment by a localized thickening of the outer wall of the cap, which is capable of being seated inside the tubular space of the outlet piece. The sealing member is preferably located at the base of the cap opposite the bottom thereof, at the rim of the outlet included thereon. The outlet piece can include in its tubular space a specific seating for receiving the sealing member, in order to improve the sealing tightness obtained between the testing tube and the inflatable bag assembled one to the other. According to an embodiment of the outlet piece, a thin wall is used to allow it to deform by receiving the sealing member at its outlet for introducing the testing tube.

According to a preferred embodiment, the axial conduit for the passage of air is formed in the thickness of the bottom of the cap. It will be appreciated that the axial extent of the conduit is advantageously limited to the thickness of the bottom of the cap so as to restrict its axial extent. Such a restriction of extent is intended in to facilitate passage of the air stream between the inflatable bag and the internal volume of the testing tube, and to avoid the cap having to bear the weight of a specific attached conduit which is liable to detract from the possibility provided of imparting flexibility to the outer sidewall of the cap by virtue of a reduction of its thickness. A projection of the conduit beyond the cap being thus avoided, the bottom of the cap can advantageously be used to form the pushing member. More particularly, the pushing member is advantageously formed by the blind end wall of the cap forming the bottom thereof, which bears axially at its outer face against the valve in the situation where the testing tube and the inflatable bag are assembled.

On an accessory basis, the valve includes projections, provided in the form of lugs or similar bearing members, which are formed on its surface facing the bottom of the cap when the testing tube and the inflatable bag are in the assembled position. Such arrangements are intended to prevent blocking of the conduit by the valve when the cap is mounted inside the outlet piece.

According to an advantageous embodiment of the rupturing member, the latter is provided in the form of a cutting blade, especially in a ring configuration, of radial geometry corresponding to that of the outlet of the testing tube which forms a counter-blade. The cutting edge of the blade preferably includes toothing to provide progressive cutting of the seal, thereby facilitating its rupture and retraction. The blade preferably includes ribs providing at least axial reinforcement, which extend as the case may be as far as the tip of the toothing.

The outlet piece advantageously further includes a guide passage for the valve, which is formed between axial ramps forming therebetween the seating for maintaining the valve in the retracted position and a channel for the circulation of air through the outlet piece in the retracted position.

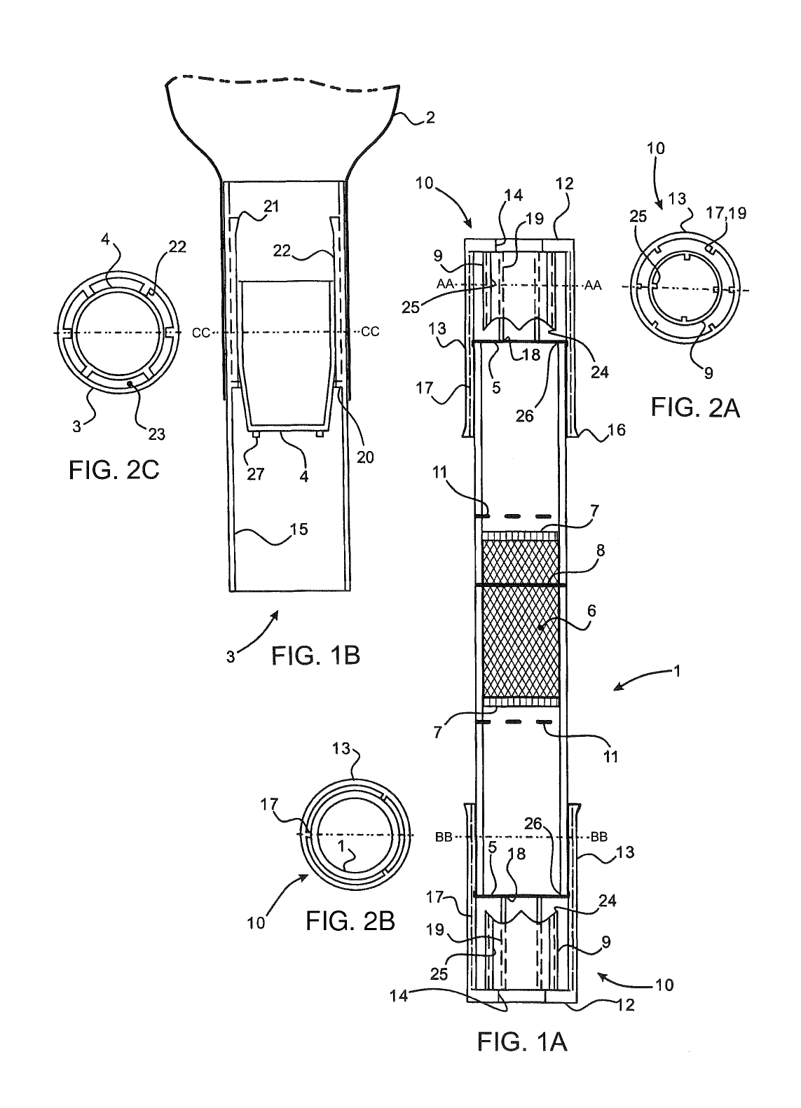

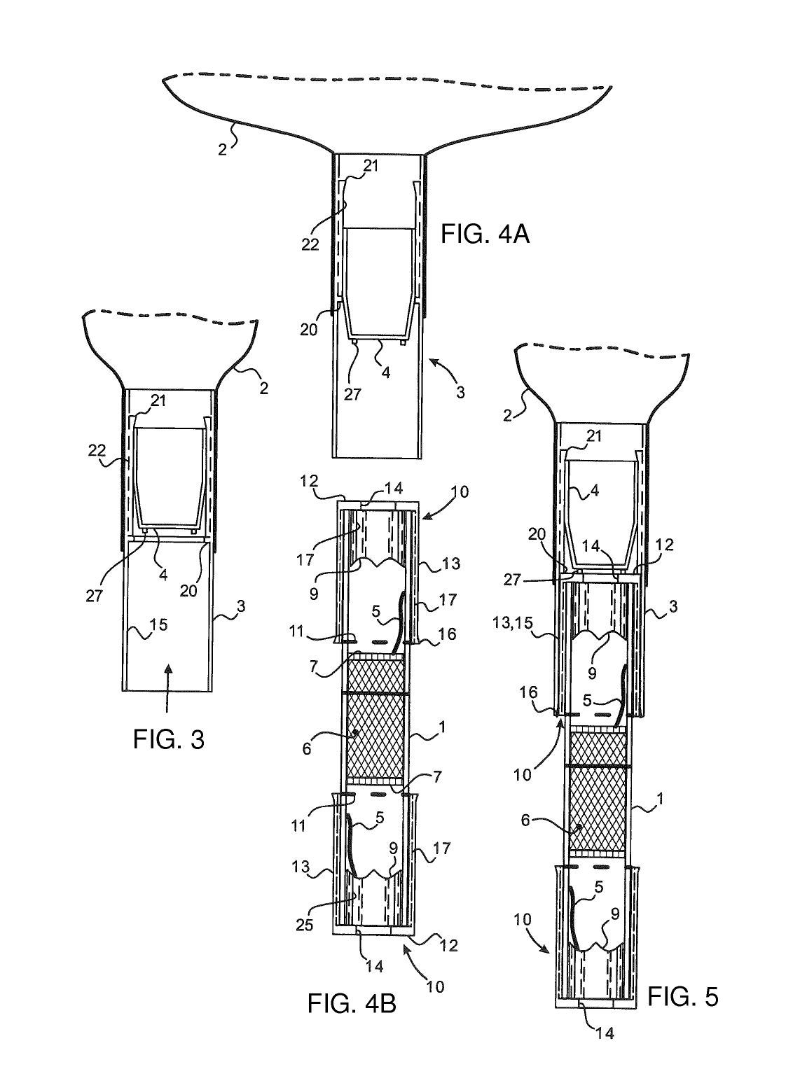

In FIGS. 1A and 1B, a chemical breath testing device includes a transparent testing tube 1 and an inflatable bag 2 provided with an outlet piece 3 incorporating a valve 4 for receiving the testing tube 1. This device is preferably a breathalyzer, the function of which is to provide an indication of the level of alcohol, particularly ethanol, present in the exhale of a user. To put the device into effect, the user fills the inflatable bag 2 by blowing air through the outlet piece 3 in the direction of the arrow as shown in FIG. 3. The testing tube 1 is prepared, as shown in FIG. 4B, by opening the end of the testing tube which are closed off by seals 5 while awaiting use. Once the inflatable bag 2 has been filled, as illustrated in FIG. 4A, the testing tube 1 is fitted to the outlet piece 3 at its proximal end in order to perform the analysis of the air contained in the inflatable bag 2, as illustrated in FIG. 5. An operator causes the inflatable bag 2 to be forcibly emptied by compression, thereby discharging the air contained therein through the outlet piece 3 and transferring it to the testing tube 1. The air passes through the testing tube 1 to enable the exhale of the user to be analyzed and to assess the level of alcohol contained therein.

The testing tube 1 is preferably formed from a transparent material such as glass, plastic or any other material deemed to be a chemically inert material for the performance of biological assays. The testing tube 1 contains within its median zone an air-permeable substrate 6 formed in particular by a granular material, which is held in a dedicated volume of the testing tube 1 by way of screens 7 respectively disposed on both sides of the substrate 6. The substrate may be a silica-based material or similar powder, or may take the form of a membrane or textile type substrate. The substrate is impregnated with a reactive agent, which is for example potassium dichromate in the specific case of a breathalyzer. The screens themselves hold the substrate by forming an interference fit with the testing tube. This fit is accomplished by sizing the screens to be of a slightly larger diameter than the inside diameter of the testing tube such that an interference is created when placing the screens inside the testing tube. In the exemplary embodiment shown, these screens 7 take the form of simple grids, but other embodiments of the screens 7 may be envisaged. The substrate 6 is impregnated with a reactive agent for inducing a progressively axial change of color, depending on the level of alcohol contained in the air passing through the testing tube 1. Preferably, a silica gel as the granular material is impregnated with chromium VI oxide (CrO₃) and sulfuric acid (H₂SO₄) as the reactive agent. A first mark 8 provided on the testing tube 1 forms an indicator of a detected alcohol threshold, this threshold being in particular a statutory threshold which must not be exceeded for the driver of a vehicle. The substrate 6 impregnated with the reagent is protected from the outside environment while the device is awaiting use, by closing off the ends of the testing tube 1 with seals 5. To facilitate the rupturing of these seals 5, the testing tube 1 is provided with rupturing members 9 carried by the caps 10, which are mounted in sliding engagement at the ends of the testing tube 1, between an initial first position shown in FIG. 1A, in which the rupturing member 9 is placed at a distance from the corresponding seal 5, and a testing position in which the seal 5 is broken as shown in FIGS. 4B and 5. The testing tube 1 includes first marks 11 to indicate the correct placement of the caps 10 in the testing position.

The device thus provides a visual qualitative test for alcohol in human breath. The reactive agent changes color in the presence of alcohol vapors. The preferred impregnated silica gel initially has a light yellow color that changes when exposed to alcohol vapors to light green. The number of crystals that change color will depend on the cut-off of the device and the amount of alcohol in the breath. The color change is produced because alcohol vapors are oxidized to acetic acid and the indicator chemicals change to chromium sulfate [Cr₂(SO₄)₃]. The majority of crystals change from yellow to light green when alcohol vapors are present at a level equal to or exceeding the cut-off of the device. The device can be designed with several cut-offs (expressed as a specific percentage of breath alcohol, e.g., 0.02, 0.04, 0.05, 0.06, 0.08 and 0.10%), with the cut-off printed on the device label.

A particular feature of the present invention resides in the organization of the caps 10 and the arrangements for cooperation between the outlet piece 3 and the proximal cap 10 fitted to the proximal end of the testing tube 1. This particular feature is applied at least for the proximal cap 10, but preferably also for the other distal cap 10 fitted to the opposite distal end of the testing tube 1, to facilitate manipulation of the testing tube 1 by joint rupturing of the two seals 5, to simplify the construction of the device and to facilitate the manufacture thereof at lower cost by using two identical caps 10. According to this particular feature, the caps 10 are disposed in a blind sleeve which is integrally molded not only with the rupturing member 5, but also with a member 12 for pushing the valve 4 and a junction member 13 for fitting the testing tube 1 to the outlet piece 3, which enables air to pass therebetween.

The junction member is formed by the outer sidewall 13 of the cap 10, with a conduit 14 for the passage of air being formed in the thickness of the bottom the cap as well. The outer sidewall 13 of the cap 10 is of a tubular shape having an outer surface corresponding to the inner surface 15 of outlet piece 3, for slidably fitting the cap 10 into the outlet piece 3. The outer sidewall 13 of the cap 10 is of limited thickness and is resiliently deformable. This deformability makes it possible to form at the base of the cap 10 opposite the bottom thereof an annular sealing member 16 which is resiliently deformable by compression between the outlet piece 3 and the testing tube 1 fitted one to the other, as shown in FIG. 5. Compression of the annular sealing member 16 serves to prevent a possible escape of air between the outlet piece 3 and the testing tube 1 during emptying of the inflatable bag 2. The deformability of the outer sidewall 13 of the cap 10 also serves for fitting the cap 10 and the testing tube 1 together, so as to prevent inadvertent detachment of the cap 10. The outer sidewall 13 of the cap 10 closely envelops the wall of the testing tube 1, fitting tightly around its corresponding end. So as not to the affect the slidable engagement of the cap 10 on the testing tube 1, centering and guide ribs 17 are provided on the inner face of the outer sidewall 13 of the cap 10. The space formed between the testing tube 1 and the outer sidewall 13 of the cap promotes the deformation thereof and ease of mounting of the caps 10 on the testing tube 1. The cap is positioned in the initial first position by an axial stop 18 formed on the inner face of the outer sidewall 13 of the cap 10. The axial stop 18 is formed from the free end of a set of additional ribs 19 which extend from the end thereof bearing on the bottom of the cap 10 up to the desired second position.

The pushing member for the valve is formed by the outer end face of the bottom 12 of the cap. In the interlocked position as illustrated in FIG. 5, the cap 10 is inserted into the inner surface 15 of the outlet piece 3, until the bottom thereof is brought to bear against an axial travel-limiting shoulder 20 which forms part of the outlet piece 3. The bottom 12 of the cap 10 pushes the valve 4 towards the inside of the inflatable bag 2, until it abuts against a seating 21 formed at the bottom of the outlet piece 3. The valve 4 includes one or more spacing elements, preferably in the form of a plurality of lugs 27 which are formed or otherwise provided at its end face facing the bottom 12 of the cap, to form a space therebetween when the cap 10 is mounted inside the outlet piece 3. The flat face of the bottom of the cap contacts the lugs when the cap is operatively engaged with the outlet piece. The space serves to provide a passage for air from the inflatable bag 2 to the testing tube 1 by preventing the end face of the valve 4 from closing off the conduit 14. The valve 4 is guided within a guide channel forming part of the outlet piece 3 and which is formed by axial ramps 22 of which the distal ends form the seating 21 against which the valve 4 is applied in the retracted position. The conformation of the seating 21 is preferably axially tapered to avoid double positioning between the end of travel of the valve 4 and the end of travel of the bottom 12 of the cap 10, and to ensure that the valve 4 is suitably held at the bottom of the outlet piece 3 when the air is blown into the inflatable bag 2. In a preferred embodiment, the bottom face of the valve extends past the limiting shoulder 20 when in the sealed position, and can therefore be moved into an open position by engagement with the cap without requiring the use of an extra protruding element to push against the valve. The ramps 22 provide between them a channel 23 for the circulation of air through the outlet piece in the retracted position of the valve 4, to allow filling of the inflatable bag 2 by moving the valve 4 towards the seating 21 under the effect of the pushing force exerted by the air being blown in, as shown in FIG. 3, or emptying thereof by pushing the valve 4 with the bottom 12 of the cap, as shown in FIG. 5.

Another particular feature of the present invention resides in the configuration of the rupturing member 9 as a cutting blade for cutting the seals 5. The cutting of the seals promotes a passage for the uniform and laminar circulation of air inside the testing tube 1. The cut seals 5 are capable of being pressed back against the wall of the testing tube 1, thereby limiting their surface area of exposure to the air flow which is otherwise liable to form an obstacle to the circulation of air. The edge of the blade 9 preferably has teeth 24 to promote even cutting of the seals 5. The blade 9 is configured as a ring, in particular of circular shape, corresponding to the geometry of the rims of the openings in the testing tube 1 which form a counter-blade 26. Reinforcing ribs 25 are provided on the blade 9, to prevent it from buckling which is liable to be caused by reason of its general thinness corresponding to the thickness of the cutting edge thereof. Other shapes of the blade can be used provided that it causes the necessary rupturing of the seal and generates a passage for sir to enter the tube.

Finally, preferred materials and dimensions for the components of the device include the following. The cap 10 is preferably made of linear polyethylene, specifically Linear Medium Density Polyethylene (LMDPE). The cap 10 is made of a single material so the blade 9, the ribs 17, 19, 25 and the tube 1 are all composed of LMDPE. The outer side wall 13, which ensures the sealing with the outlet piece, has a thickness of 0.5 mm. The blade has a thickness of 1 mm at its base and 0.6 mm at its end which includes teeth 24. The ribs 17, 19, 25 have a thickness of 0.5 mm. The bottom of the cap 10 is defined by a thickness of 1.25 mm at the conduit level.

What is claimed is:

1. A chemical breath testing device comprising:
a transparent testing tube with an inlet and outlet end, wherein at least one end of the testing tube is closed off by at least one seal;
an air permeable substrate fixedly disposed within the testing tube and impregnated with a reagent reactive to an analyte in human exhale;
at least one end cap disposed on the at least one closed end of the testing tube and in sliding engagement with the testing tube so that it is movable from a first position to a second position, with the cap having an axial conduit for the passage of air therethrough and containing a rupturing member for rupturing the seal;
an inflatable bag which cooperates with the end of the testing tube that has the cap, the inflatable bag containing a tubular outlet piece fluidly connected with the inflatable bag, wherein the outlet piece incorporates a valve moveable from an open to closed position to allow air blown into the bag to remain inside the bag; and
a junction member that is formed by the outside surfaces of the cap, and which is configured to sealingly engage the tubular outlet piece of the inflatable bag to create an air-tight seal between the cap and outlet piece, the cap being further equipped with a pushing member formed by a shoulder on the cap that provides axial support for urging the valve towards the open position and towards the inside of the inflatable bag when the junction member receives the outlet piece,
wherein the testing tube is prepared for usage by moving the cap from the first position to the second position to cause the at least one seal to rupture,
wherein the testing tube is used to analyze the person's breath for presence of the analyte.

2. The chemical breath testing device of claim 1, wherein both the inlet and outlet ends of the tube are closed off by seals on each end, and further with caps as described in claim 1 provided on both ends, such that the inflatable bag can be received by the junction member on either end of tube.

3. The chemical breath testing device of claim 2, wherein the inflatable bag collects and is filled with human exhale and, after the cap on the inlet end is moved to the second position, the inflatable bag is received by and sealing engaged to the junction member on the inlet end of the testing tube, with the engagement causing the pushing member to open the valve and allow the passage of air through the axial conduit, into the testing tube and through the substrate for reaction with the reagent to determine the presence of the analyte in the collected human exhale.

4. The chemical breath testing device of claim 2, wherein the inflatable bag in a deflated state is received by and sealing engaged to the junction member on the outlet end of the testing tube, and, after the caps on the each end are moved to the second position, the bag is filled with human exhale by a person blowing into the inlet end of the testing tube and through the substrate for reaction with the reagent to determine the presence of the analyte in the human exhale, with the bag inflating to collect the human exhale after passing through the substrate.

5. The chemical breath testing device of claim 1, wherein the outlet piece further comprises:
a valve guide for guiding the valve during its movement from the closed to open positions;
a stop for limiting the travel of the valve;
an air channel for providing fluid communication from the inflatable bag to the valve; and
a shoulder formed on an inner surface of the outlet piece,
wherein the valve is a circular block having tapered sides and at least one spacer member configured and dimensioned such that when the valve is in the closed position, the thicker end of the valve is in sealing contact with the shoulder and when the pushing member pushes the valve towards the inside of the bag, the valve is moved to the open position while being guided by the valve guide to the stop, where the tapered shape of the valve allows a gap to form between the valve and shoulder and the spacer member(s) create an air space between the pushing member and valve, thereby allowing the passage of air from the air channel and through the valve.

6. The chemical breath testing device of claim 5, wherein the at least one spacer member comprises a plurality of lugs on a bottom surface of the valve facing the cap and the axial shoulder limits the travel of the outlet piece on the junction member.

7. The chemical breath testing device of claim 1, which further comprises one or more markings on the testing tube for indicating the position(s) of the cap(s), and/or one or more markings arranged with respect to the substrate for providing an indication of the quantity of analyte in human exhale.

8. The chemical breath testing device of claim 7, wherein a first marking is used to indicate the second position of one cap, and a second marking is used to indicate an amount of analyte contained in human exhale which passed through and has reacted with the reagent on the substrate.

9. The chemical breath testing device of claim 7, which further comprises a third marking on the testing tube to indicate the second position of the other cap.

10. The chemical breath testing device of claim 8, wherein the amount of analyte is indicated by the reagent on the substrate changing color, such that when a portion of the substrate changes to a different color which surpasses the second marking, the portion of the substrate surpassing the second marking indicates that a measured level of analyte has been achieved.

11. The chemical breath testing device of claim 10, wherein the analyte is alcohol in human exhale and the measured level is a blood alcohol level.

12. The chemical breath testing device of claim 1, wherein the substrate comprises a granular or membrane material that contains the reactive agent, with the granular or membrane material fixedly disposed in the tube by screens on each end thereof, with the screens sized to be larger than the inner diameter of the testing tube such that when the substrate and screens are placed inside the testing tube, interference created between the testing tube and screen creates an interference fit which allows the screens to securely hold the substrate in a desired position inside the testing tube.

13. The chemical breath testing device of claim 1, wherein the cap takes the form of a blind sleeve having a flexible and deformable outer wall which resiliently caps the outer wall of the testing tube with tolerances sufficient enough to allow slideable engagement therewith.

14. The chemical breath testing device of claim 13, wherein the outer sidewall of the cap includes on its inner face a stop for axial positioning of the cap on the testing tube in the initial position.

15. The chemical breath testing device of claim 14, wherein the outer sidewall of the cap includes on its inner face centering ribs providing resilient bearing contact against the outer surface of the testing tube.

16. The chemical breath testing device of claim 15, wherein the outer sidewall of the cap includes on its outer face an annular sealing member between the cap and the tubular space of the outlet piece.

17. The chemical breath testing device of claim 1, wherein the axial conduit for the passage of air is formed in the bottom of the cap surrounding the valve and testing device, the rupturing member is provided in the form of a cutting blade of radial geometry sized to be about the size of the inner diameter of the testing tube to allow the testing tube to form a counter-blade.

18. The chemical breath testing device of claim 17, wherein the edge of the blade includes teeth and the blade includes ribs for providing axial reinforcement, with the ribs at least reinforcing the teeth.

19. A chemical breath testing device comprising:
a transparent testing tube with two ends, wherein both ends of the testing tube are closed off by at least one seal;
an air permeable substrate fixedly disposed within the testing tube and impregnated with a reagent reactive to an analyte in human exhale, wherein the substrate is positioned symmetrically within the middle of the tube;
the same end cap disposed on each sealed end of the testing tube and in sliding engagement with the testing tube so that each cap is movable from a first position to a second position, with both caps having an axial conduit for the passage of air therethrough and containing a rupturing member for rupturing the seal;
an inflatable bag which cooperates with either end of the symmetric testing tube that has the cap, the inflatable bag containing a tubular outlet piece fluidly connected with the inflatable bag, wherein the outlet piece incorporates a valve moveable from an open to closed position to allow air blown into the bag to remain inside the bag; and such that the inflatable bag;
a junction member that is formed by the outside surfaces of the cap, and which is configured to sealingly engage the tubular outlet piece of the inflatable bag to create an air-tight seal between the cap and outlet piece, the cap being further equipped with a pushing member formed by a shoulder on the cap that provides axial support for urging the valve in the outlet piece towards the open position and towards the inside of the inflatable bag when the junction member receives the outlet piece,
wherein the testing tube is prepared for usage by moving both caps from the first position to the second position to rupture each of the seals, and
wherein the testing tube is used to analyze the person's breath for presence of the analyte.

20. The chemical breath testing device of claim 19, wherein the testing tube includes one or more markings for indicating the second position(s) of the cap(s), and/or to indicate the amount of analyte contained in human exhale; and wherein the analyte markings are arranged symmetrically with respect to the testing tube and substrate such that either end of the testing tube can be inserted into the outlet piece and still provide an indication of the quantity of analyte in human exhale.

21. A method of using the chemical breath testing device of claim 1, which comprises the steps of:
preparing the testing tube for use by moving the at least one end cap from the first to second position to provide a passage for air to enter the tube;
inflating the inflatable bag with human exhale; and
passing the human exhale through the substrate in the testing tube for measurement of the analyte.

22. The method of claim 21, which further comprises initially having a person fill the inflatable bag by blowing into the outlet piece, and, after the cap on the inlet end is moved to the second position, engaging the outlet piece with the junction member of the testing tube, thus opening the valve so that the bag contents can pass into the testing tube and through the substrate for analysis of the analyte.

23. The method of claim 21, which further comprises engaging the outlet piece of a deflated bag with the junction member of the testing tube; having a person fill the inflatable bag with exhale after the cap on the inlet end is moved to the second position by blowing into the inlet end of the tube wherein the exhale passes into the tube, through the substrate and into the bag; and removing the inflated bag by removing the outlet piece from the junction member, thus closing the valve.

24. A method of using the chemical breath testing device of claim 19, which comprises the steps of:
preparing the testing tube for use by moving the at least one end cap from the first to second position to provide a passage for air to enter the tube;
inflating the inflatable bag with human exhale; and
passing the human exhale through the substrate in the testing tube for measurement of the analyte.

25. The method of claim 24, which further comprises initially having a person fill the inflatable bag by blowing into the outlet piece, and, after the cap on the inlet end is moved to the second position, engaging the outlet piece with the junction member of the testing tube, thus opening the valve so that the bag contents can pass into the testing tube and through the substrate for analysis of the analyte.

26. The method of claim 24, which further comprises engaging the outlet piece of a deflated bag with the junction member of the testing tube; having a person fill the inflatable bag with exhale after the cap on the inlet end is moved to the second position by blowing into the inlet end of the tube wherein the exhale passes into the tube, through the substrate and into the bag; and removing the inflated bag by removing the outlet piece from the junction member, thus closing the valve.
